(19) United States
(12) Patent Application Publication
(10) Pub. No.: US 2008/0296198 A1
(43) Pub. Date: Dec. 4, 2008

(54) Capped Ampoule to Be Filled With A Liquid By Vacuum and Corresponding Production Method

(76) Inventors: Thierry Chamorot, Vaugrigneuse (FR); Christophe Guilbert, Villeneuve Les Avignon (FR); Jean-France Baeskens, Artannes sur Indre (FR); Christian Vanacker, Creteil (FR)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/997,623

(22) PCT Filed: Aug. 1, 2006
(86) PCT No.: PCT/EP2006/064920

§ 371 Date: Jun. 24, 2008

(30) Foreign Application Priority Data
Aug. 3, 2005 (FR) 05/08285

(51) Int. Cl. B65D 1/09; A61J 1/06

(52) U.S. Cl. 206/528; 53/471; 206/524.1

(57) ABSTRACT

The invention relates to an ampoule forming a recipient for a liquid substance, made of a brittle rigid thermofusible material, comprising a body having, at one of its ends, a filling point by suction of the liquid substance. The invention is characterized in that the end opposite said point forms an opening for emptying the recipient, sealed and removable closing means being placed on the opening.

The field of the invention is that of pharmaceutical or parapharmaceutical product packaging. More specifically, the invention relates to packaging in the form of ampoules, designed to contain a drinkable or non-drinkable liquid substance.

In the field of the invention, three main types of packaging are known

so-called “two points” ampoules;

bottle ampoules;

vials.

Bottle ampoules are most often used for packaging injectable pharmaceutical products or cosmetic products.

These ampoules are packaged in a special room with a filtered atmosphere. They are produced by heat-forming glass tubes so that they have a flat base and a flared or sealed opening, with a constriction provided between the body of the ampoule and the opening so as to form an area that breaks upon opening.

The filling of these ampoules is performed with needles that penetrate the opening of the ampoules and that make it possible to supply homogeneous amounts of products.

They are closed by a conventional flame sealing technique.

The vials are also made of glass and filled by needle systems or nozzles. They commonly have thread finishes enabling the placement of a screwable top.

The needle filling technique allows for good precision in the amount of product supplied to the interior of the container.

However, this technique does not make it possible to obtain very high filling rates, without an increase in the number of needles in the systems used, which would involve considerable investments.

Another technique is used to increase the filling rate, when it is not necessary to have a high level of precision.

This is a vacuum filling step.

To do this, the “two points” ampoules mentioned above are used. These ampoules are produced using glass tubes, and have, in view of their filling, a (flame-) closed end and an open end.

To carry out the filling, the ampoules of this type are placed in crystallizers. The crystallizers are moved by handling to a vat containing the liquid substance intended to fill the ampoules.

The crystallizers are placed in the vat so as to have the open ends directed downward, at a predetermined level in the liquid substance. The next operation consists of creating a vacuum in the vat so as to evacuate the air inside the vat and the ampoules. When the vacuum has been created, the vacuum is “broken” by returning the vat to atmospheric pressure.

The return to atmospheric pressure results in a filling of the ampoules, which act as pumps suctioning the liquid.

When the entire vat and the ampoules have returned to atmospheric pressure, the filling is complete.

The level of filling is dependent on the vacuum applied to the vat.

After filling, the crystallizers are returned and the open ends that have been used for the filling are washed with hand sprays with a cold water/hot water alternation in order to clean the end.

The points thus cleaned are then sealed using a torch.

To extract the liquid from the ampoules, the user must break off a point, place the end thus opened above a container, then break the other point to enable the liquid to be poured.

However, as indicated above, these ampoules are made using a glass tube, which is by nature a breakable material.

It is therefore possible, when the user breaks the points of the ampoule, for glass chips to form, possibly so small that they cannot be detected by the user.

These glass chips can then fall into the container into which the liquid is poured, or be driven by the liquid when it is poured from the ampoule.

Of course, it is unacceptable to expose the user to such a risk of ingestion of glass chips, which can of course damage the digestive system with more or less serious consequences.

Moreover, it is possible that the points are not broken cleanly, leading to a cutting edge that can cause injuries when handling the ampoule.

This should of course be avoided.

Some countries have prohibited the use of these ampoules for the reasons mentioned above, and therefore use vials with caps.

The invention is intended to overcome the disadvantages of the prior art.

More specifically, the invention is intended to propose a container for a liquid substance that makes it possible to use a vacuum filling technique and that prevents, or at the very least considerably limits, the risks of chipping of the material of which the container is made.

The invention is also intended to provide such a container that is simple and practical for the user.

The invention is also intended to provide such a container with a simple design and that is easy to implement.

Another objective of the invention is to propose a method for producing such a container.

These objectives, as well as others that will appear below, are achieved by the invention which relates to an ampoule forming a container for a liquid substance, made of a rigid breakable thermofusible material, of the type including a body having, at one of its ends, a point for filling by suctioning said liquid substance, characterised in that the end opposite said point forms an opening for emptying said container, with tight and removable closure means being attached to said opening.

An ampoule is thus obtained that does not present risks, when opening it for pouring out its contents, or of forming chips of the breakable material of which it is made (unless of course it is handled improperly, causing involuntary stress).

Indeed, to pour the contents of the ampoule, it is simply necessary to release the opening by removing the removable closure means.

Therefore, there is no longer any question of breaking the ampoule, as is the case with the conventional prior art solutions.

Thus, the risks (except of course in the case of improper handling) of ingestion of chips of material as well as the risks of forming a cutting edge are eliminated.

Advantageously, said body has a cylindrical tube shape, and said opening has a diameter corresponding to that of said tube.

An ampoule with a simple design, and that can easily be produced, is thus obtained.

Indeed, the opening can be obtained very simply when producing the ampoule, simply by cutting a tube, without requiring any other forming of the tube.

In addition, such an opening has a diameter enabling the introduction of air during pouring, which consequently occurs almost instantaneously.

According to a preferred embodiment, said closure means include a seal.

According to another advantageous embodiment, said closure means include a cap.

In one case or the other, said closure means are preferably attached removably to said opening by a heat-sealing or gluing technique.

According to another possible alternative, said opening has a peripheral edge on which said closure means are attached.

It is thus possible to increase the support surface of the closure means, so as optionally to ensure a better hold thereof on the container.

In this case, according to a preferred alternative, said edge extends toward the inside of the container.

The overall bulk of the ampoules is thus limited, making it possible in particular to have them close to one another in the crystallizers used for their filling.

In other words, it is unnecessary to modify or replace the crystallizers and the filling machines used with the solutions known from the prior art.

According to a second possible alternative, said edge extends toward the outside of the container.

The ampoule is preferably made of glass.

Of course, other materials with similar mechanical features can be used without going beyond the scope of the invention.

The invention also relates to a method for producing an ampoule made of a rigid breakable thermofusible material, including a step of heat-forming a tube so as to obtain an ampoule having, at one of its ends, a point for filling by suctioning said liquid substance, characterised in that it includes a step of heat-forming the end opposite said point so as to form an opening for emptying said container, and a step consisting of attaching tight and removable closure means to said opening.

Preferably, said step consisting of attaching tight and removable closure means to said opening is a step of heat-sealing a seal.

According to another advantageous solution, said heat-sealing step is performed while said ampoule maintains a residual heat due to said heat-forming steps.

Other features and advantages of the invention will become more clear on reading the following description of a preferred embodiment of the invention, and some of its alternatives, given by way of illustrative and non-limiting examples, and appended drawings in which:

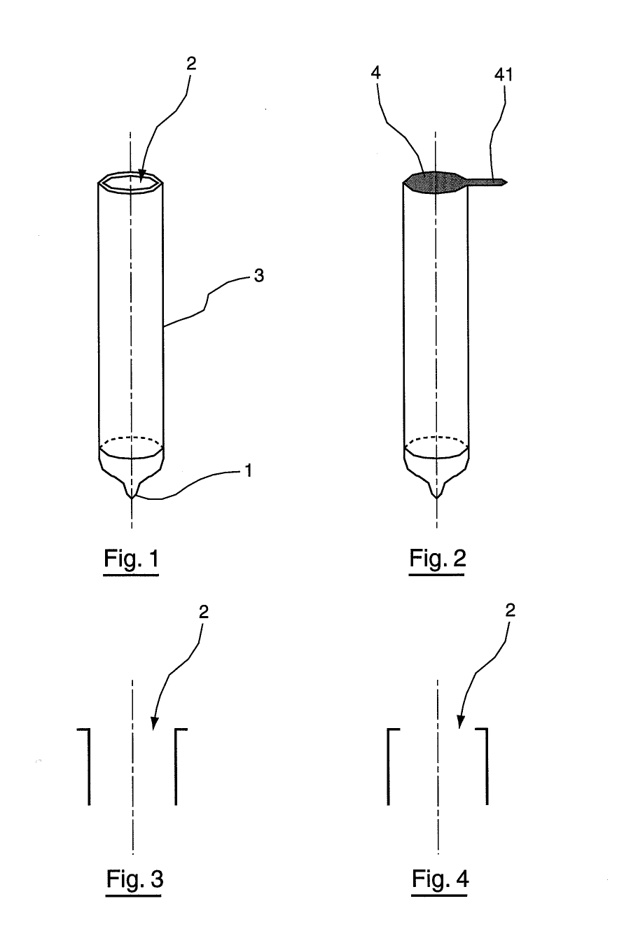

FIGS. 1 and 2 each show a view of an ampoule according to the invention, respectively without and with closure means;

FIGS. 3 and 4 each show a partial view of an alternative embodiment of an ampoule according to the invention.

As mentioned above, the principle of the invention lies in the fact of producing an ampoule forming a container that has, at one on of its ends, a filling point, and, at the other of its ends, an opening provided with removable closure means.

This is shown in FIGS. 1 and 2.

According to the present embodiment, the ampoule is made with a cylindrical glass tube and has, at one of its ends, a filling point 1, and, at its other end, an opening 2 of which the diameter is identical to that of the body 3 of the ampoule.

It is noted that, according to the phase of use of such an ampoule, the point 1 is open or closed.

Indeed, in general, the production of the ampoule and the filling thereof are performed at distinct sites.

In addition, at the end of production, the ampoules appear with the filling point open, so as to enable the filling according to a method described in greater detail below.

They are then sent in this form to the site where the filling is carried out.

Of course, once filled, the filling points are closed up and the ampoules are packaged and distributed with their points closed.

According to the embodiment shown in FIG. 2, the removable closure means are formed by a seal 4 attached to the opening 2, for example by a heat-sealing technique (or gluing according to another possible embodiment).

It is understood that the heat-sealing (or gluing) is performed so as to obtain a peelable seal, i.e. designed to resist a predetermined pulling force, and to be detached from the ampoule with a greater force.

Such a seal can be formed by a complex including aluminium, with a low thickness (for example 20 to 80 microns), and can be assembled to the ampoule with one or more layers of heat-sealable products, optionally by adding PVC or PET (or any other suitable material) in order to reinforce the seal.

The seal can also be printed and/or coloured.

Preferably, the seal has a tab 41 facilitating the gripping of the seal when it is to be removed.

According to a possible alternative, the closure means are formed by a cap, attached to the ampoule also by heat-sealing or gluing or any other suitable system.

FIGS. 3 and 4 show possible alternatives according to which the opening 2 has a peripheral edge 21 so as to increase the surface supporting the seal.

Such an edge can extend toward the outside of the opening 2 (FIG. 3) or toward the inside of the opening (FIG. 4).

It is also noted that the point 1 has the shortest possible length so as to reduce the overall size of the ampoule, and so as to optimise the mechanical strength of the point.

Indeed, the point of an ampoule according to the invention is not designed to be broken, unlike the points of the ampoules of the prior art. To pour the liquid contents from the ampoule, it is simply necessary to tear the seal and overturn the ampoule, as the opening is sufficient for enabling the introduction of air simultaneously to the pouring of the liquid (which was not the case with the “two points” ampoules with which it was necessary to break each point, one serving to pour the liquid and the other to enable air to pass through).

The method for producing ampoules according to the invention is as follows.

Glass tubes are introduced into rotary machines as conventionally used to produce the “two points” ampoules of the prior art.

The ampoules are thus heat-formed so that they have an open point at one of their ends and an opening at the other of their ends.

The ampoules leaving the furnace maintain a residual heat used to carry out the heat-sealing of the seals.

Additional heat is supplied in order to bring the ampoules to a temperature high enough for the heat-sealing of the seals by pressing the seals onto the glass.

The temperature of the glass is checked, without contact, in order to regulate the heating of the glass before the heat-sealing of the seal.

Once the seals have been heat-sealed on the ampoules, the tightness thereof (on the seal side) is controlled by pressure (after cooling of the ampoules), using a pressure controller, so as to remove any unsatisfactory ampoules.

The ampoules are filled according to a technique that is identical or similar to that described for filling “two points” ampoules.

1-12. (canceled)

13: Ampoule forming a container for a liquid substance, made of glass, of the type including a body having, at one of its ends, a filling point, said point being closed, characterised in that the end opposite said point forms an opening for emptying said container, with tight and removable closure means being attached to said opening, said closure means being designed to be removed to pour the liquid contents from the ampoule.

14: Ampoule forming a container for a liquid substance according to claim 1, characterised in that said body has a cylindrical tube shape, which opening has a diameter corresponding to that of said tube.

15: Ampoule forming a container for a liquid substance according to claim 1, characterised in that said closure means include a seal.

16: Ampoule forming a container for a liquid substance according to claim 1, characterised in that said closure means include a cap.

17: Ampoule forming a container for a liquid substance according to claim 1, characterised in that said closure means are removably attached to said opening by a heat-sealing or gluing technique or any other suitable means.

18: Ampoule forming a container for a liquid substance according to claim 1, characterised in that said opening has a peripheral edge on which said closure means are attached.

19: Ampoule forming a container for a liquid substance according to claim 18, characterised in that said edge extends toward the inside of the container.

20: Ampoule forming a container for a liquid substance according to claim 18, characterised in that said edge extends toward the outside of the container.

21: A method for producing a container for a liquid substance, the method comprising:
(i) heat-forming a tube made of a rigid breakable thermofusible material, the tube defining first and second ends, the first end being configured for filling the container by suctioning;
(ii) heat-forming the second end of the tube to form an opening for emptying the container; and
(iii) attaching a tight and removable closure to the opening of the second end of the tube.

22: The method of claim 21, where attaching a tight and removable closure to the opening of the second end comprises heat-sealing a seal.

23: The method of claim 22, where heat-sealing is performed while the container maintains a residual heat from the heat-forming steps.

24: A container for a liquid substance, the container comprising:
(i) a body made of a rigid breakable thermofusible material, the body defining a cavity and having a first end and a second end;
(ii) the first end of the body having an opening configured for filling the body with a liquid substance by suction; and
(iii) the second end of the body having an opening with a tight and removable closure configured for emptying the container.

25: The container of claim 24, where the cavity in the body is cylindrical and the openings of the first end and second end have the same diameter as the cylindrical cavity.

26: The container of claim 24, where the closure includes a seal.

27: The container of claim 24, where the closure includes a cap.

28: The container of claim 24, where the closure is removably attached to the opening of the second end by heat-sealing or gluing.

29: The container of claim 24, where the opening of the second end has a peripheral edge on which the closure is attached.

30: The container of claim 29, where the peripheral edge extends toward the interior of the cavity in the body.

31: The container of claim 29, where the peripheral edge extends toward the exterior of the body.

32: The container of claim 24, where the rigid breakable thermofusible material is glass.
